(19) United States
(12) Patent Application Publication
(10) Pub. No.: US 2021/0226313 A1
(43) Pub. Date: Jul. 22, 2021

(54) WIRELESS INTERFACE ADAPTER

(71) Applicant: NOVIN ENTERPRISES LLC, SAN JOSE, CA (US)

(72) Inventors: Eliah Novin, San Jose, CA (US); Wade Novin, Sherman Oaks, CA (US)

(21) Appl. No.: 16/942,748

(22) Filed: Jul. 29, 2020

Related U.S. Application Data
(60) Provisional application No. 62/854,235, filed on May 29, 2019.

(51) Int. Cl. H01Q 1/08; H01Q 1/24; H01Q 1/36

(52) U.S. Cl. CPC H01Q 1/088; H01Q 1/36; H01Q 1/242

(57) ABSTRACT

Technologies regarding the wireless interface adapter for the transmission of control protocol in the professional lighting are disclosed. An example wireless interface adapter, includes: an enclosure; an XLR-style connector coupled to the enclosure; a printed circuit board assembly mounted in the enclosure; an RF module mounted on the printed circuit board; user interface indicators mounted on the printed circuit board and protruding out of the enclosure via small holes of the enclosure; user interface buttons or switches mounted on the printed circuit board and protruding out of the enclosure via small holes of the enclosure; a power supply system mounted in the enclosure; a USB connector mounted on the printed circuit board; and an antenna connected to the RF module.

### RELATED APPLICATION

This applicant claims the benefit of U.S. provisional patent application 62/854,235, filed May 29, 2019, which is hereby incorporated by reference in its entirety.

### TECHNICAL FIELD

The present disclosure generally to wireless interface adapter for the transmission of control protocol and more specifically to enclosure of the wireless interface adapter for the transmission of control protocol in the professional lighting, event and visual productions industries, among others.

### BACKGROUND

The DMX512 standard is one of the widely used as a control protocol in the professional lighting, event and visual productions industries, among others. One of this control relies on wired connections between a master controller unit and many receivers. Every receiving device requires a wired connection in a multi-drop bus configuration with a maximum number of nodes allowed on any one segment.

Various wireless solutions are available that send the signal such as DMX512 over a wireless link using unlicensed ISM and standard RF transmission methods on different publicly available frequency bands. The radio signal carries the DMX512 protocol which is converted or embedded and then reconstructed or extracted from the carrier.

Conventional adaptor for the transmission of control protocol is large, clumsy, and with a higher cost. The present disclosure will allow for the reception and transmission of DMX512 or related protocol signals with the industry standard RDM protocol in a portable, handheld size.

### SUMMARY

The technologies regarding the wireless interface adapter for the transmission of control protocol in the professional lighting are disclosed.

An example wireless interface adapter, in some implementations, includes: an enclosure; an XLR-style connector coupled to the enclosure; a printed circuit board assembly mounted in the enclosure; an RF module mounted on the printed circuit board; user interface indicators mounted on the printed circuit board and protruding out of the enclosure via small holes of the enclosure; user interface buttons or switches mounted on the printed circuit board and protruding out of the enclosure via small holes of the enclosure; a power supply system mounted in the enclosure; a USB connector mounted on the printed circuit board; and an antenna connected to the RF module.

In some implementations, the antenna is internally mounted.

In some implementations, the antenna is externally, detachably mounted.

In some implementations, the RF module is configured to receive and transmit a signal carrying DMX512 protocol.

In some implementations, the user interface includes: a trigger that provides a function of powering on the wireless interface adapter to full functionality on applications of an external power source; and a control option that suppresses the function and makes the power to some internal components remain off to provide more power to recharge the power supply system.

In some implementations, a default response of the control option is either to power on completely, to remain in power off status, or to require no user or input or a specific user input or action.

In some implementations, the power supply system includes an internal battery.

In some implementations, an input to the power supply system includes an external source of AC or DC voltage.

The wireless interface adapter, in some implementations, further includes an AC/DC transformer-based charger connected via the USB connector.

In some implementations, the XLR-style connector is a 3 or 5 pin connector.

In some implementations, the XLR-style connector is detachable from the enclosure without using tools.

In some implementations, the XLR-style connector is rotatable.

In some implementations, the XLR-style connector is configured to plug into an external device's DMX port.

In some implementations, a material of the enclosure is plastic or acrylic.

In some implementations, a material of the enclosure is metal.

### BRIEF DESCRIPTION OF THE DRAWINGS

FIG. 1 is a general perspective illustrating an example enclosure of the wireless interface adapter for the transmission of control protocol in accordance with some implementations of the present disclosure.

FIGS. 2A-2B are side view perspectives illustrating an example enclosure of the wireless interface adapter for the transmission of control protocol in accordance with some implementations of the present disclosure.

FIGS. 3A-3B are front and back view perspectives illustrating an example enclosure of the wireless interface adapter for the transmission of control protocol in accordance with some implementations of the present disclosure.

FIG. 4 is an exploded view illustrating an example enclosure of the wireless interface adapter for the transmission of control protocol in accordance with some implementations of the present disclosure.

FIG. 5 is a view from all side illustrating an example enclosure of the wireless interface adapter for the transmission of control protocol in accordance with some implementations of the present disclosure.

FIG. 6 is a 3D colored view from all side illustrating an example enclosure of the wireless interface adapter for the transmission of control protocol in accordance with some implementations of the present disclosure.

The implementations disclosed herein are illustrated by way of example, and not by way of limitation, in the figures of the accompanying drawings. Like reference numerals refer to corresponding parts throughout the drawings.

### DETAILED DESCRIPTION

The technologies regarding the wireless interface adapter for the transmission of control protocol in the professional lighting are disclosed. The technologies described in the present disclosure may provide the following technical advantages.

First, conventional adaptor for the transmission of control protocol is large, clumsy, and with a higher cost. The present disclosure will allow for the reception and transmission of DMX512 or related protocol signals with the industry standard RDM protocol in a portable, handheld size.

Second, by using a smaller and more efficient spatially enclosure with a specially selected material such as plastic or acrylic, the technologies of the present disclosure enable the adaptor to be lighter, cheaper, and portable.

Third, the technologies disclosed an enclosure allow for the body of it to rotate about the XLR connector. The mechanism allowing for rotation may use stop limits or allow for unlimited movement.

Fourth, the power supply of the present disclosure will be uninterruptible between an external source and an internal battery. Upon removal of the external source, the supply will seamlessly and without interruption to the device's functions switch to the internal source.

Fifth, the user interface of the present disclosure in the form of lights, indicators, or LEDs and/or switches, buttons, dials or touch-screens to control the basic functions of the radio module and power on and off the device.

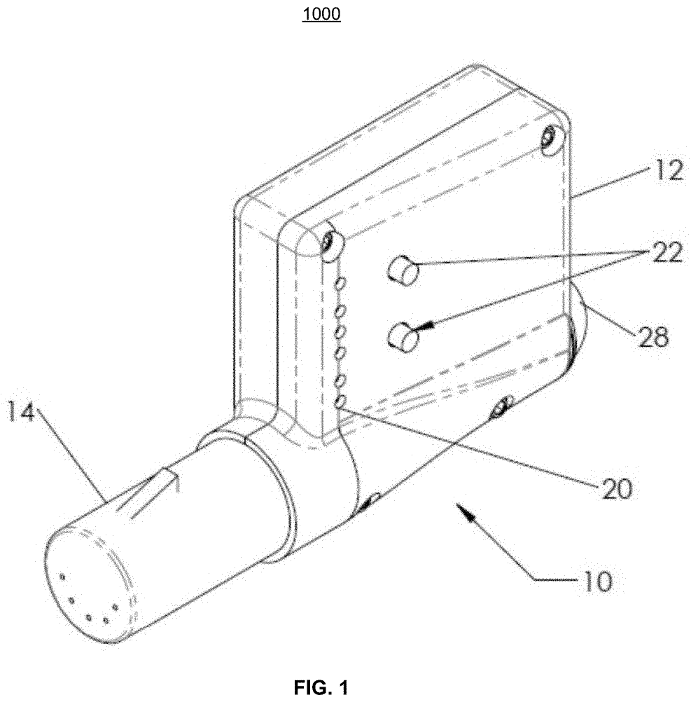

FIG. 1 is a general perspective illustrating an example enclosure of the wireless interface adapter for the transmission of control protocol in accordance with some implementations of the present disclosure.

The wireless interface adapter 10 (Wireless DMX interface adapter) includes an enclosure 12, an XLR-style connector 14, a printed circuit board assembly 16, an RF module 18, user interface indicators 20, user interface buttons or switches 22, an internal battery 24, a USB connector 26, and an antenna 28.

A: Enclosure

The enclosure 12 shall house all the internal components necessary for the device to function as well as all necessary connectors. One embodiment will use a multipart design that can be molded or machined from plastic or metal. Another embodiment will use an extruded plastic or metal part. The design consideration is the ability of the device to plug into a fixture's or device's ‘DMX’ port without the need for additional hardware cabling or connective pieces. Once attached to the fixture or device of the present disclosure will not obstruct other controls or ports that are reasonably and ergonomically designed.

A standard ‘XLR’ style 3 or 5 pin connector 14 is installed in the enclosure. This is mounted in such a way so that the entire device can be inserted and removed easily and without requiring tools or special procedures beyond that of connector specifications.

One embodiment of the enclosure may allow for the body of it to rotate about the XLR connector. The mechanism allowing for rotation may use stop limits or allow for unlimited movement.

Another embodiment may include an articulated joint to allow for positioning options of the connector relative to the enclosure body. This mechanism can use mechanical joints of various designs.

The specific style and construction of the enclosure is unique and shall be recognizable as distinct from other products. The markings, names, product identification and other symbols are designed to distinguish the present disclosure from other devices in the same field.

B: Power Supply

The power supply, constructed of components and connections on a printed circuit board assembly 26, is designed to furnish regulated DC voltages to all internal electronic components. Input to this supply can be an external source of AC or DC voltage. An internal battery 24 can be present as another source and can be part of the power supply system.

The power supply can also recharge a battery, either internal or external and of any chemistry type. The charging may be facilitated, in one embodiment, with an AC/DC transformer based charger connected via a USB connector 26.

The power supply will be uninterruptible between an external source and an internal battery. Upon removal of the external source, the supply will seamlessly and without interruption to the device's functions switch to the internal source. Upon application of external power, the supply will switch to it as necessary. Various embodiments of the device will handle multiple power inputs without disturbance to the overall functions.

C: User Interface and Operation

The technologies in the present disclosure will allow for a user interface in the form of lights, indicators, or LEDs 20 and/or switches, buttons, dials or touch-screens 22 to control the basic functions of the radio module 18 and power on and off the device.

One embodiment features a trigger that powers on the device to full functionality on the application of an external power source. The user interface 20 and 22 can allow a control option to suppress this function. In this way the power to some internal components remains off to provide more power to recharge the internal battery. The default response can either be to power on completely, remain in the off power status or can require no user or input or a specific user input or action.

Another input source will control the radio module as specified in the manufacturers respective data sheets and application notes.

D: RF Module

The RF module 18 which enables reception of a signal carrying the DMX512 and RDM information can be from any number of manufacturers. It may use Wi-Fi, Zigbee, Bluetooth, or any propriety encoding or transmission method as any particular manufacturer so supplies. The present disclosure may use a part, parts of, or a complete implementation of a manufacturer's radio transmission platform. An antenna 28 is connected to the module to facilitate wireless transmission. In one embodiment, as illustrated, the antenna in internally mounted. Other embodiments may have an external, removable antenna or an antenna integrated with the enclosure 12.

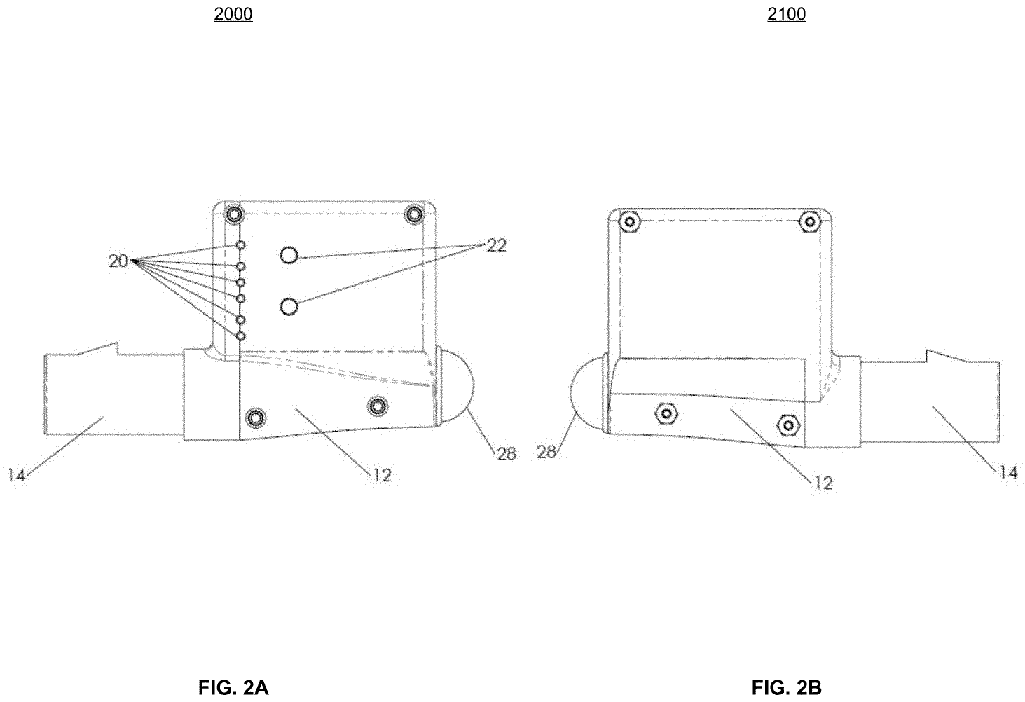

FIGS. 2A-2B are side view perspectives illustrating an example enclosure of the wireless interface adapter for the transmission of control protocol in accordance with some implementations of the present disclosure.

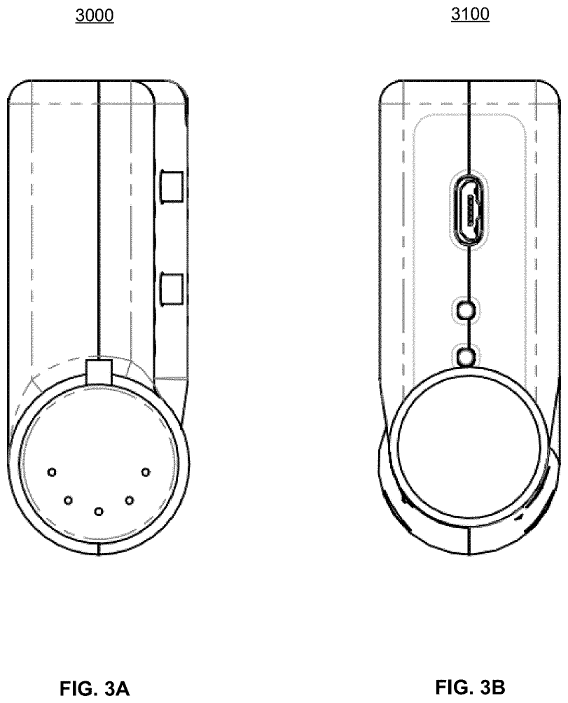

FIGS. 3A-3B are front and back view perspectives illustrating an example enclosure of the wireless interface adapter for the transmission of control protocol in accordance with some implementations of the present disclosure.

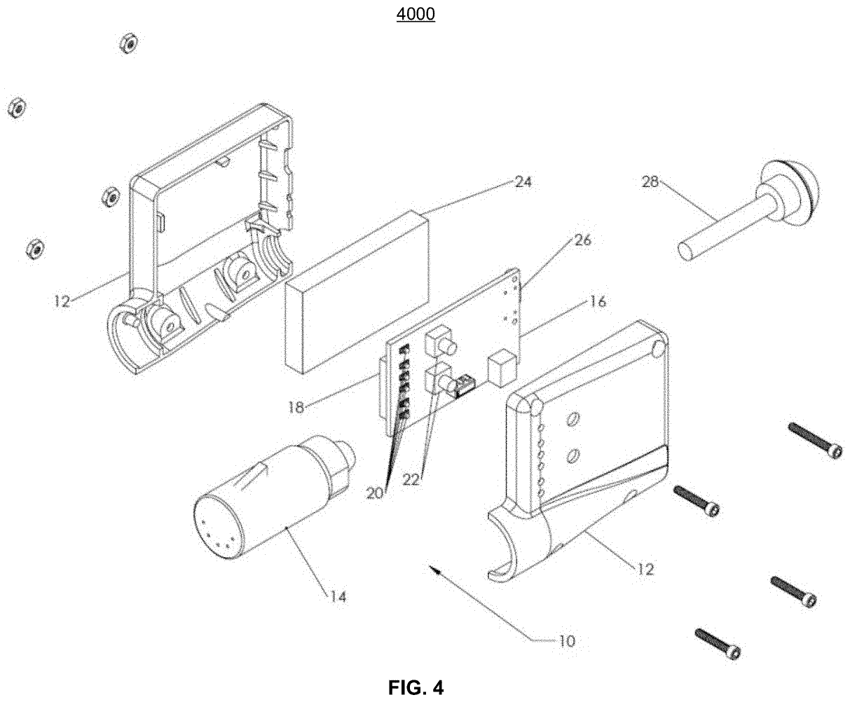

FIG. 4 is an exploded view illustrating an example enclosure of the wireless interface adapter for the transmission of control protocol in accordance with some implementations of the present disclosure.

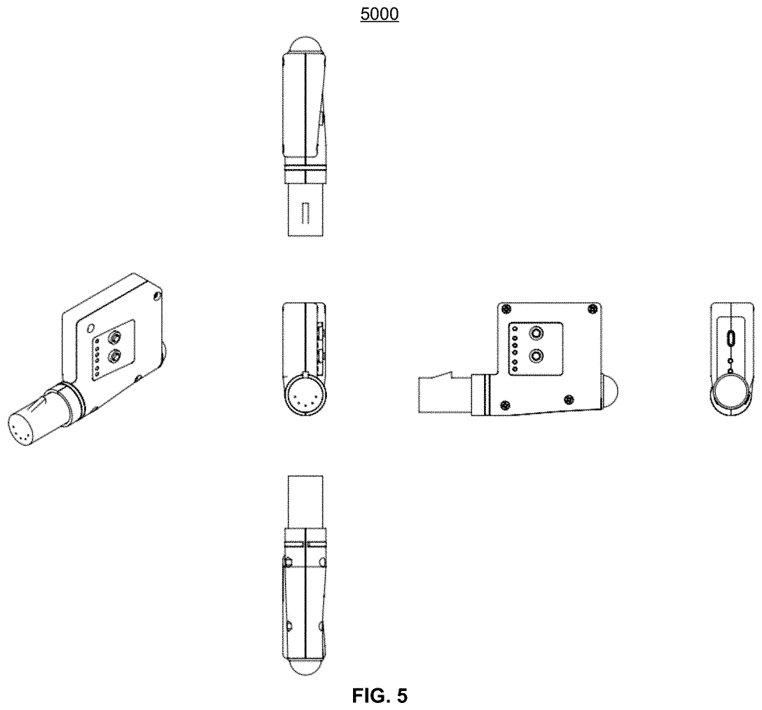

FIG. 5 is a view from all side illustrating an example enclosure of the wireless interface adapter for the transmission of control protocol in accordance with some implementations of the present disclosure.

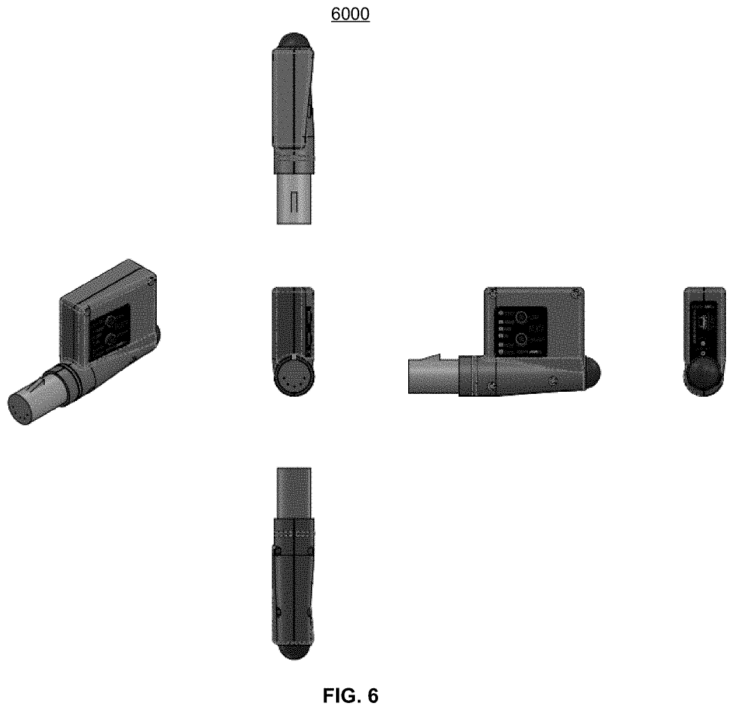

FIG. 6 is a 3D colored view from all side illustrating an example enclosure of the wireless interface adapter for the transmission of control protocol in accordance with some implementations of the present disclosure.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first column could be termed a second column, and, similarly, a second column could be termed the first column, without changing the meaning of the description, so long as all occurrences of the “first column” are renamed consistently and all occurrences of the “second column” are renamed consistently. The first column and the second are columns both column s, but they are not the same column.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A wireless interface adapter, comprising:
an enclosure;
an XLR-style connector coupled to the enclosure;
a printed circuit board assembly mounted in the enclosure;
an RF module mounted on the printed circuit board;
user interface indicators mounted on the printed circuit board and protruding out of the enclosure via small holes of the enclosure;
user interface buttons or switches mounted on the printed circuit board and protruding out of the enclosure via small holes of the enclosure;
a power supply system mounted in the enclosure;
a USB connector mounted on the printed circuit board; and
an antenna connected to the RF module.

2. The wireless interface adapter as claimed in claim 1, wherein the antenna is internally mounted.

3. The wireless interface adapter as claimed in claim 1, wherein the antenna is externally, detachably mounted.

4. The wireless interface adapter as claimed in claim 1, wherein the RF module is configured to receive and transmit a signal carrying DMX512 protocol.

5. The wireless interface adapter as claimed in claim 1, wherein the user interface comprises:
a trigger that provides a function of powering on the wireless interface adapter to full functionality on applications of an external power source; and
a control option that suppresses the function and makes the power to some internal components remain off to provide more power to recharge the power supply system.

6. The wireless interface adapter as claimed in claim 5, wherein a default response of the control option is either to power on completely, to remain in power off status, or to require no user or input or a specific user input or action.

7. The wireless interface adapter as claimed in claim 1, wherein the power supply system comprises an internal battery.

8. The wireless interface adapter as claimed in claim 1, wherein an input to the power supply system comprises an external source of AC or DC voltage.

9. The wireless interface adapter as claimed in claim 1, further comprises an AC/DC transformer based charger connected via the USB connector.

10. The wireless interface adapter as claimed in claim 1, wherein the XLR-style connector is a 3 or 5 pin connector;

11. The wireless interface adapter as claimed in claim 1, wherein the XLR-style connector is detachable from the enclosure without using tools.

12. The wireless interface adapter as claimed in claim 1, wherein the XLR-style connector is rotatable.

13. The wireless interface adapter as claimed in claim 1, wherein the XLR-style connector is configured to plug into an external device's DMX port.

14. The wireless interface adapter as claimed in claim 1, wherein a material of the enclosure is plastic or acrylic.

15. The wireless interface adapter as claimed in claim 1, wherein a material of the enclosure is metal.
